(19) United States
(12) Patent Application Publication
(10) Pub. No.: US 2026/0154545 A1
(43) Pub. Date: Jun. 4, 2026

(54) LEARNING ROBUST DATA REPRESENTATIONS WITH CROSS-MODALITY KNOWLEDGE SHARING

(71) Applicant: Tensor Type Inc., Palo Alto, CA (US)

(72) Inventors: Siddharth Srivastava, New Delhi (IN); Gaurav Sharma, Newark, CA (US)

(21) Appl. No.: 18/698,334

(22) PCT Filed: Mar. 8, 2024
(86) PCT No.: PCT/US2024/019213

§ 371 Date: Apr. 3, 2024

(30) Foreign Application Priority Data
Mar. 8, 2023 (IN) 202311015451

(51) Int. Cl. G06N 3/08

(52) U.S. Cl. CPC G06N 3/08

(57) ABSTRACT

Methods, systems, and computer programs are presented for learning robust embeddings from multiple modalities and tasks with a unified architecture. A framework is presented for learning robust embeddings from multiple modalities and tasks with improved performance and generalization. The framework includes modality-specific encoders, a shared transformer backbone, and task-specific heads. It allows for end-to-end training and cross-modality knowledge sharing, and the framework results show improvements over the state-of-the-art results on popular benchmarks. A training strategy is presented for leveraging knowledge from multiple modalities and an iterative training mechanism for self-supervised masked pretraining.

### CROSS-REFERENCE TO RELATED APPLICATIONS

This application claims the benefit of India Provisional Patent No. 202311015451, filed Mar. 8, 2023, and entitled “Omnivec—Generalized Framework for Tasks and Data Agnostic Learning with Cross Modality Knowledge Sharing.” This provisional application is herein incorporated by reference in its entirety.

### TECHNICAL FIELD

The subject matter disclosed herein generally relates to methods, systems, and machine-readable storage media for training models that generate data embeddings for different modalities of items.

### BACKGROUND

Most research in learning-based methods has been towards designing and training networks for specific tasks. Many applied machine learning methods aim to extract useful representations from data. However, most such methods are modality and task-specific.

One problem is that this approach may limit the ability of machine learning models to learn from and generalize to different types of data. If the model is only trained on a specific task or modality, it may not be able to effectively process or make predictions on new types of data that it has not been trained on.

Another problem is that this approach may require significant resources and time to develop and train separate models for each task and modality. This can be particularly challenging in cases where there are multiple modalities or tasks that need to be integrated into a single system.

Furthermore, this approach may not facilitate cross-modal knowledge sharing, which can limit the ability of machine learning models to learn from and integrate information across different types of data.

### BRIEF DESCRIPTION OF THE DRAWINGS

Various appended drawings illustrate examples of the present disclosure and cannot be considered limiting its scope.

FIG. 1 illustrates the process of learning robust representations of multi-modal data with cross-modal sharing, according to some examples.

FIG. 2 is a flowchart of a method for learning robust data representations, according to some examples.

FIG. 3 provides architectural details of the shared backbone network, according to some examples.

FIG. 4 is a flowchart of a method for generating multi-modal embeddings, according to some examples.

FIG. 5 is a flowchart of a method for training the shared backbone network, according to some examples.

FIG. 6 illustrates some example results for different approaches according to some examples.

FIG. 7 illustrates the training and use of a machine-learning model, according to some example examples.

FIG. 8 is a flowchart of a method for learning robust data representations, according to some examples.

FIG. 9 is a block diagram illustrating an example of a machine upon or by which one or more example process examples described herein may be implemented or controlled.

### DETAILED DESCRIPTION

Example methods, systems, and computer programs are directed at learning robust multi-modal data representations. Examples merely typify possible variations. Unless explicitly stated otherwise, components and functions are optional and may be combined or subdivided, and operations may vary in sequence or be combined or subdivided. In the following description, numerous specific details are set forth to provide a thorough understanding of examples. However, it will be evident to one skilled in the art that the present subject matter may be practiced without these specific details.

In some aspects, the learning-based tasks across modalities are addressed in a joint framework. Techniques are presented for an approach in such direction to learn multiple tasks in multiple modalities with a unified architecture. A unified data- and task-agnostic learning framework, with a single backbone is presented, according to some examples, in which modalities in different domains can aid the learning process. Further, a novel training mechanism is presented that groups tasks and constructs batches by mixing inter-modality datasets.

A disclosed network is composed of task-specific encoders, a common trunk in the middle, and is followed by task-specific prediction heads. Pre-train is performed by self-supervised masked training, and then sequential training for the different tasks is performed. The network is trained on several modalities, e.g., visual, audio, text, and 3D.

Experiments showed that using a joint network to train across modalities leads to meaningful information sharing, and this allows for better-than-existing approaches on most of the benchmarks. With experiments on 22 datasets spanning across image, video, point cloud, depth, audio, and text, it was proven that the proposed framework is highly generalizable while being extremely robust. The presented techniques also generalize well to seen tasks with different data distribution and can adapt to unseen tasks effectively.

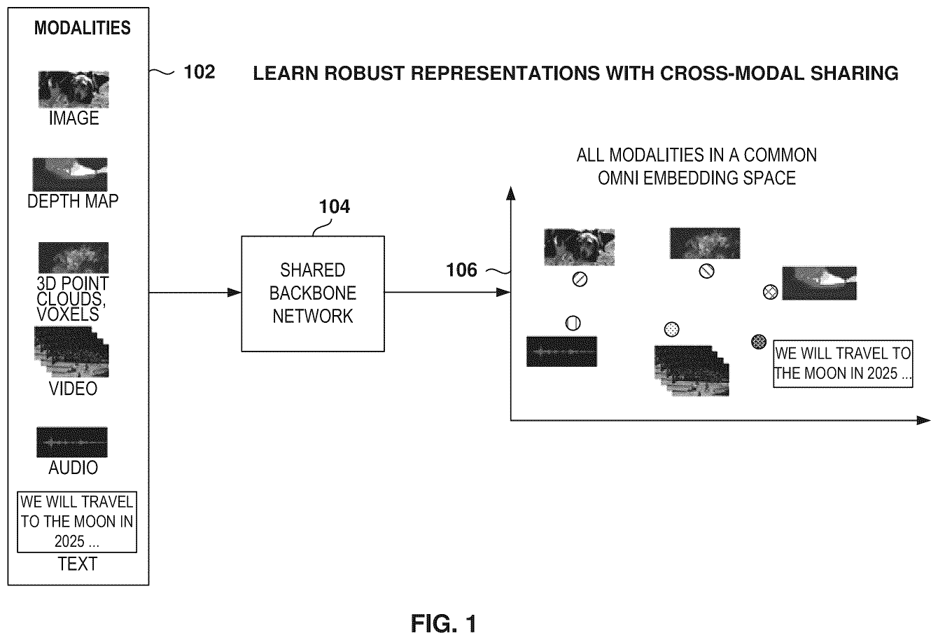

FIG. 1 illustrates the process of learning robust representations of multi-modal data with cross-modal sharing, according to some examples.

In some examples, the knowledge of multiple modalities 102 is shared to embed the modalities 102 in a common embedding space 106. The modalities 102 may include any combination of images, depth maps, 3D point clouds, videos, audio, text, etc. Although some examples are presented with reference to the subset of their modalities 102, the principles presented herein may be applied to all combinations of the modalities 102.

A shared backbone network 104 is trained on the multiple modalities 102 sequentially, allowing the embeddings (e.g., vectors) to generalize across modalities. The shared backbone network 104 trains on the multiple modalities 102 in a sequential manner. Further, example techniques do not assume any correspondence between the training data (e.g., paired training sets across modalities), which is different from existing approaches where correspondence in the data among modalities is assumed.

Further, tasks are learned together with the unified shared backbone network 104, which leads to regularization effects as a large number of shared parameters are trained to perform varied tasks and hence are more likely to extract meaningful representations from data without overfitting to one task or modality.

Learning tasks together also aids in utilizing available labeled data from different domains, hence potentially eliminating the cost and effort of labeling large amounts of data in a specific modality for a specific task. With the ability to share knowledge from multiple modalities 102 from different domains (e.g., visual, acoustic, textual), the modality-agnostic learning frameworks have shown to provide better robustness than traditional unimodal networks.

The embeddings represent data points from the various modalities 102 that are converted into vectors. One characteristic of these embedding vectors is that, if two input data points from the same modality (e.g., two images of cats) are used, the resulting embeddings should be close to each other, indicating a smaller distance between them than the case where the two data points are not related to each other. Further, if two items from different modalities (e.g., a video and a text transcript of the video) are related, the embeddings will be close to each other; that is, the distance between the embeddings will be smaller than the distance of the embeddings if the two items were not related.

Some existing methods use a single source of information to train their models. For example, to teach a machine to recognize images, a large dataset of images is used to train the model. However, this approach only allows the model to learn from a single modality.

Multimodal learning, on the other hand, involves using multiple modalities to train a model. One existing approach is to use pairs of data. For example, using a dataset of images and their corresponding textual descriptions. By training a model on this pair of data, it is possible to learn how to map images to text. Still, this approach is limited because it is only able to process pairs of modalities, so it would be necessary to have multiple training methods to train on the different pairs of modalities.

The example techniques presented do not have a dependency on paired data; instead, they learn robust embeddings without having any paired data amongst the different modalities. Since paired data is not required, it is possible to apply the techniques to numerous modalities simultaneously, e.g., seven different modalities. However, the same principles may be applied to a larger number of modalities.

To work with multiple modalities simultaneously, a training strategy is presented that allows leveraging knowledge from multiple modalities while the shared backbone network 104 is trained, including creating batches for training with items from multiple modalities.

Experiments showed that the use of multiple modalities, such as image and text, to learn embeddings can be beneficial and improve performance and accuracy. The results showed that the performance was superior to methods that only utilized text, which indicates that the approach is capable of extrapolating information from other modalities.

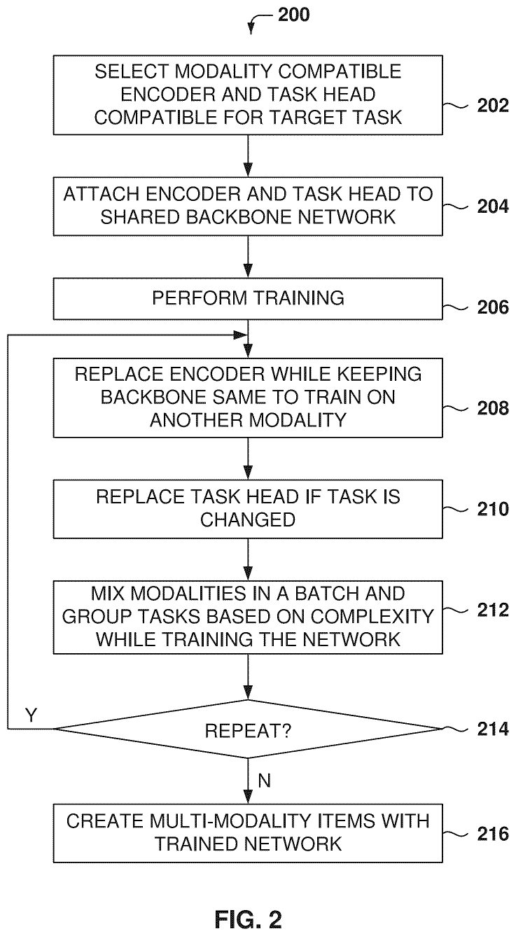

FIG. 2 is a flowchart of method 200 for learning robust data representations, according to some examples. While the various operations in this flowchart are presented and described sequentially, one of ordinary skill will appreciate that some or all of the operations may be executed in a different order, be combined or omitted, or be executed in parallel.

Operation 202 is for selecting a modality-compatible encoder and an appropriate task head that is compatible with the target task. A task refers to the objective associated with the use of machine learning, such as object classification, object detection, text summarization, image recognition, scene recognition, action recognition, etc. The task head is the model that will perform the target task.

From operation 202, method 200 flows to operation 204 for attaching the encoder to the beginning of the shared backbone network and the task head to the end of the shared backbone network.

From operation 204, method 200 flows to operation 206 to perform the training of the shared backbone network.

From operation 206, method 200 flows to operation 208 for replacing the encoder while keeping the backbone the same if the process will train on a different modality.

From operation 208, method 200 flows to operation 210 for replacing the task head if the task is changed from the previous iteration.

From operation 210, method 200 flows to operation 212 for mixing modalities in a batch and grouping the tasks based on their complexity while training the network. To further facilitate learning of better representations and cross-modal information sharing, the network is trained on numerous tasks. The network is trained in a sequential manner for different tasks.

From operation 212, method 200 flows to operation 214 to perform a check to determine if a new iteration will be performed. If a new iteration is to be performed, method 200 flows back to operation 208, and if no more iterations are to be performed, method 200 flows to operation 216.

Operation 216 is for creating multi-modality items with the trained network. In some examples, the tasks are grouped based on the extent of information exploited by the tasks across different modalities, e.g., a semantic segmentation task forces the network to embed more local information in the learned representation, as compared to a classification task. In addition to grouping the tasks, the training data is constructed by mixing samples from each modality for a particular task. The network is trained by replacing the modality encoder for each modality while keeping the task heads and backbone network the same. In some examples, the network is pretrained using masked pretraining.

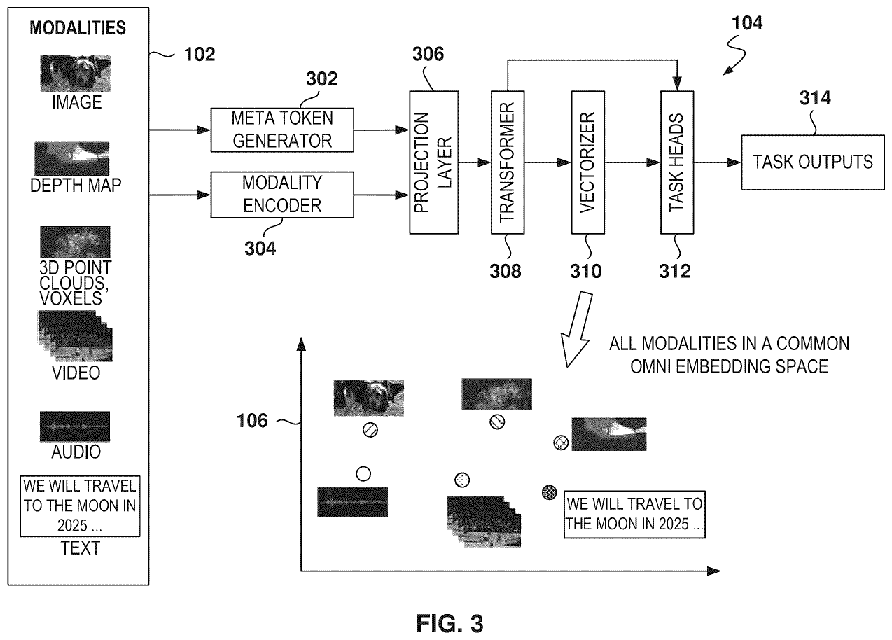

FIG. 3 provides architectural details of the shared backbone network, according to some examples. The example techniques provide a framework that learns embeddings in a shared space from different modalities and delivers a high generalization performance. Further, the embeddings are learned from distinct modalities with modality-specific encoders, which are processed by a shared transformer backbone. The transformer backbone maps the input embeddings to a shared embeddings space. The network is then trained in an end-to-end manner.

The shared backbone network 104 comprises modality encoder 304, one for each modality 102, meta token generator 302, projection layer 306, transformer 308, vectorizer 310, and task heads 312. Each task head 312 is used for a respective task.

The modality encoder 304 takes as input one modality and extracts feature embedding for the modality. Different modality encoders are available for each of their modalities. In some examples, the modality encoder 304 can be a transformer or a convolutional neural network, or the modality encoder 304 can directly use raw signals. Still, other types of modality encoders may be used. The presented methodology allows incorporating any appropriate deep network as a modality encoder.

In some examples, domain-specific transformer-based encoders are used for each of the modalities, as shown in Table 1 below.

TABLE 1

| Modality | Domain | Network |
|---|---|---|
| Image | Visual | Vision Transformer (ViT) |
| Depth maps | Visual | Vision Transformer (ViT) |
| Video | Visual | Video Vision Transformer (ViViT) |
| 3D point clouds | Visual | Simple3D-former |
| Audio | Auditory | Audio Spectrogram Transformer (AST) |
| Text | Language | BERT |

It is noted that the networks in the visual and auditory domains are based on the Vision Transformer architecture, e.g., image and depth directly use ViT. Further, ViViT differs from ViT in input tokenization that extends 2D patches to 3D (spatiotemporal mapping), and the audio AST transformer differs from ViT in the input representation used, e.g., using log-mel spectrograms instead of images. The Simple3D-former for 3D point clouds uses a 2D ViT transformer as the base network with modified positional embeddings and a tokenization approach. In some examples, each of the models is trained from scratch.

Meta token generator 302 extracts meta tokens from the input modalities. The meta token is a vector representation that encodes the type of modality (I), size of temporal dimension (T), height (H), width (TV) in spatial dimension, number of channels (C), and length or number of tokens L) In general, the meta tokens can also hold additional information to make the framework adapt to additional modalities. The value in each of these representation variables is conditioned on the type of modality; e.g., nonspatial data may include H and W with the other non-spatial parameters set to a value associated with a special token that indicates a lack of information for that parameter.

Projection layer 306 takes as inputs the intermediate representations from the modality encoder 304 and the meta tokens and outputs patches based on input representation. The output patches are provided as input to the subsequent transformer 308. The projection layer 306 generates an n-dimensional vector for each patch by applying linear projection, and this projection is applied with a learnable weight Wᵢₚ∈ [symbol] for each modality i.

In the context of machine learning, a patch refers to a subset or fragment of data, often used in the context of image processing and computer vision tasks. For example, for image processing and computer vision, in tasks such as object detection, image classification, or segmentation, an image is often divided into smaller regions or patches. Each patch represents a small portion of the image. These patches are then fed into a machine-learning model for analysis. Using patches allows the model to focus on local features and patterns within the image. In some examples, Convolutional Neural Networks (CNNs), commonly used in image-related tasks, operate by scanning over an image using filters (kernels) to extract features. These filters are essentially small windows or patches that move across the image, performing convolution operations. This process enables CNNs to capture spatial hierarchies of features in images.

The meta tokens make the projection layer 306 adaptable to varying numbers and dimensions of input patches to generate latent representations compatible with the subsequent transformer network. For instance, RGB images are represented as I∈ [symbol] , with t equal to 1 (number of frames, that is, the image includes one frame) and c is equal to 3, which is the number of channels, one each for Red, Green, and Blue.

Video may be represented as V∈ [symbol] , with t frames (t>1), which is the number of video frames to be used for each sample, and c equal to 3 for the number of channels, that is, video has a time dimension associated with the sequence of the frames within the video. It is noted that 1 in the superscripts is the value used when the information for the item is not available or not used. Additionally, for depth maps, the depth is D∈ [symbol] , with c equal to 4 channels, and for point clouds P, P∈ [symbol] with I points. For audio A, A∈ [symbol] with spectrogram input, and for text L, L∈ [symbol] with I tokens in the text, that is, I refers to the length of the text. Each patch x is processed independently and projected to an embedding e followed by a normalization process (e.g., a LayerNorm).

Transformer 308, also referred to herein as the transformer network, is the common part of the framework and can be a ‘bottleneck’ block. While different modalities may arrive to transformer 308 through different encoders 304, all modalities have to pass through this transformer 308. The transformer network inputs the patches generated by the projection layer 306 and outputs features (e.g. feature vectors). The framework can use any standard transformer architecture; in some examples, the multi-head attention involves standard self-attention and GeLU (Gaussian Error Linear Unit) activation prior to the vectorizer 310.

Vectorizer 310 takes feature vectors of the patches from the transformer network as input, and outputs embeddings for the original data point. Vectorizer 310 outputs a single embedding e=f(X) for an input X. The output embeddings of the vectorizer are referred to herein as Omni embeddings or multimodal embeddings, as these emnbeddings constitute knowledge from multiple tasks and modalities due to the forward pass from the transformer 308 where the cross-modality and cross-task information are infused.

In some examples, the output patches are concatenated and passed through a linear layer to obtain a d-dimensional embedding. At the time of training, the outcome of vectorizer 310 is used as input to task heads 312. However, using the outcome of vectorizer 310 as input to task head 312 is optional as task head 312 may also directly take input patches from the previous transformer 308. Once the model for vectorizer 310 has been trained, the output from vectorizer 310 can be used for fine-tuning and evaluation on downstream tasks.

Task heads 312 are Σᵢ_{^{th}}Tᵢₕ independent networks which learn task h for every i^{th} modality. The task heads can generally be any computer vision, natural language processing, or some other modality-specific task, e.g., classification (image, video, audio, text), segmentation (image, point clouds), etc. Each task head 312 is used for a specific purpose and provides a specific task output 314.

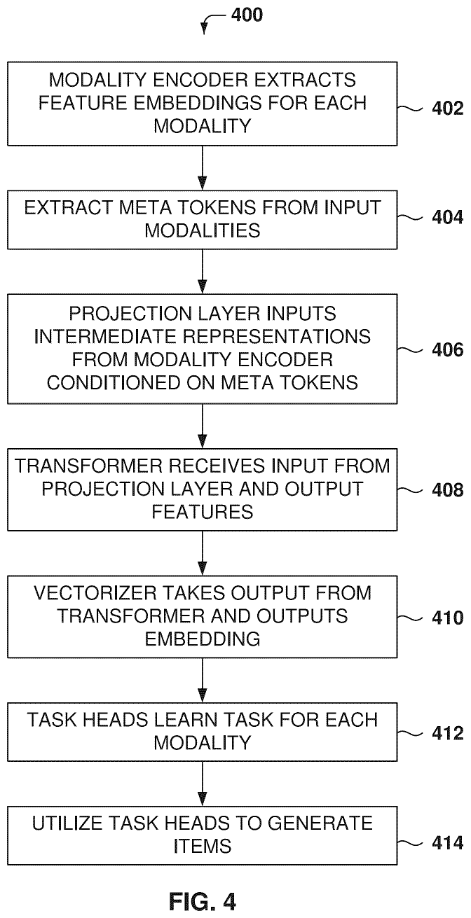

FIG. 4 is a flowchart of a method for generating multi-modal embeddings, according to some examples. While the various operations in this flowchart are presented and described sequentially, one of ordinary skill will appreciate that some or all of the operations may be executed in a different order, be combined or omitted, or be executed in parallel.

Operation 402 is for extracting, by the respective modality encoder, feature embeddings for the modality.

From operation 402, method 400 flows to operation 404 for extracting the meta tokens from the input modalities.

From operation 404, method 400 flows to operation 406 for receiving, by the projection layer, the intermediate representations of the inputs from the modality encoder and the meta tokens. The projection layer then outputs the patches.

From operation 406, method 400 flows to operation 408 for receiving, by the transformer, the input from the projection and generating the output feature embeddings. In some examples, the projection layer is a neural network.

From operation 408, method 400 flows to operation 410 for receiving, by the vectorizer, the output from the transformer and presenting the embedding of the item as output. In some examples, the output of the transformer is sent directly to the task heads during training. Still, the output of the transformer is sent to the vectorizer during the inference phase to generate the embeddings.

From operation 410, method 400 flows to operation 412 for learning, by each task head, the corresponding task for the corresponding modality.

From operation 412, method 400 flows to operation 414 for generating new items by the task heads.

For each modality, there is a specific input representation required for an encoder (e.g., a neural network) to encode it. When solving a classification task, the output of the network will have multiple values representing the probabilities of each class being present in the input. On the other hand, for an object detection task, the output needs to be in the form of bounding box coordinates. The task heads are the output layer of the network and vary based on the task.

Some examples have a learning mechanism that addresses the problem of requiring specific information in multimodal applications. This methodology allows for the utilization of any amount of data without the need for extensive labeling or specific data types.

Some examples implement a supervised method, meaning it requires some form of supervision. Within the supervised method, there are several ways of providing supervision, such as by defining the similarity between images and text or by specifying the class of an image and the summary of the text. In both cases, the network is responsible for sharing information between the two modalities.

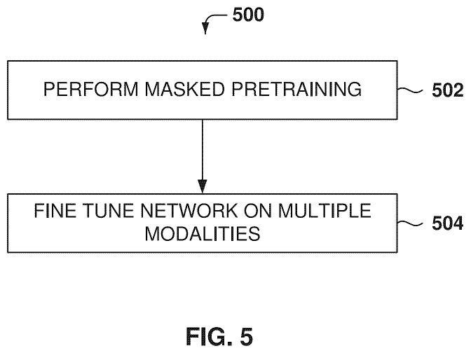

FIG. 5 is a flowchart of a method 500 for training the shared backbone network, according to some examples. While the various operations in this flowchart are presented and described sequentially, one of ordinary skill will appreciate that some or all of the operations may be executed in a different order, be combined or omitted, or be executed in parallel.

The shared backbone network is trained in two stages. Operation 502 is for performing masked pretraining. Operation 504 is for fine-tuning the network on multiple modalities.

In some examples, the network is pretrained with masked autoencoders. For example, for an input with N patches, K patches are masked. Then, the non-masked patches and their positions are fed to the encoder. For each modality, the encoder described in Table 1 is used, followed by the transformer that outputs per patch embeddings. The per-patch embeddings are concatenated with K replicas of learnable mask tokens, resulting in N embeddings. With masked pre-training, some part of the input is removed randomly, and then the network is asked to deconstruct the input.

Further, corresponding positional embeddings are added to each of the N embeddings, and the result is passed to the decoder. In some examples, the same masking strategy for modalities from visual and auditory domains is used. For textual data, the sentences are randomly permuted, and a small fraction f of tokens are used as predicted tokens, and then an 8:1:1 BERT strategy is used to construct mask tokens.

The training objective is to minimize the reconstruction error between the input and decoder outputs. For image, video, point clouds, and audio spectrogram inputs, the 12 distance between the K predicted and target patches is minimized. For visual inputs, the input samples are normalized to zero mean and unit variance. For textual data, the permuted language modeling of XLNet may be used as the objective.

To train the network on multiple modalities and tasks, modality mixing and task grouping are presented. The model is trained using a collection of h tasks T_{i,h}, for i^{th} modality. The tasks are grouped into simple and dense tasks. This categorization between simple and dense tasks is based on the complexity of the dataset and outputs, e.g., a classification task predicts a single label for a given input, irrespective of the size of the input; therefore, this is considered a simple task. On the other hand, a segmentation or depth prediction task requires each pixel to be predicted; therefore, this is considered a dense task.

Since there is no assumption of any correspondence between data from various modalities, samples from all datasets for a particular task are mixed to share knowledge among the various modalities. In another approach, mini-batches from each dataset are constructed separately. This strategy of constructing mini-batches is referred to herein as modality mixing. Specifically, for a particular task h belonging to a type of task t (simple, dense), for each modality i, sample s_{t,i,h} is extracted from the datasets.

For example, in some examples, the user has a limit of 1,000 samples, and the user may select 200 image samples, 200 audio samples, 200 depth samples, 200 audio samples, and 200 video samples for cross-training.

After task grouping and modality mixing, the network is trained in an end-to-end manner iteratively for simple and dense tasks. In some examples, the network is trained for E epochs. Further, the network is trained for v₁ epochs with minibatches from simple tasks and v₂ epochs for dense tasks. The training continues iteratively, e.g., by switching between simple and dense tasks for E epochs.

Table 2 below shows a list of tasks and corresponding datasets for task-group-based training after masked pretraining. Each task is assigned to a task group (simple, dense) based on the complexity of the dataset and output.

TABLE 2

| | | | Task |
|---|---|---|---|
| Task | Dataset | Modality | Group |
| Image Recognition | iNaturalist-2018 | Image | Simple |
| Scene Recognition | Places-365 | Image | Dense |
| Video Action Recognition | Kinetics-400 | Video | Simple |
| Video Action Recognition | Moments in Time | Video | Dense |
| Audio Event | ESC50 | Audio | Simple |
| Classification | | | |
| Point Cloud Segmentation | S3DIS | Point Cloud | Dense |
| Text Summarization | DialogueSUM | Text | Dense |
| Point Cloud Classification | ModelNet40-C | Point Cloud | Simple |

The result is a good set of weights for the different models, which can transform any data of the considered modality into art embedding. If a new task is identified, e.g., to characterize faces or classify chairs, and although the methodology has not worked with chairs or been trained on what a face is, the Some examples framework will still be able to extract good embeddings for these new tasks.

In some examples, to search images based on text, the embeddings are extracted for the text and the images, and when one piece of text is related to one image, their embeddings will be close to each other in the multimodal embedding space.

This kind of scenario becomes possible because there is a plethora of data across the Internet, and it is practically impossible to train on each and everything. With the multimodal training, it is possible to implement tasks that are more complicated than matching images to text.

For example, in the case of an autonomous vehicle car, the goal may be “what is the object in front of the car?” In order to train such a method, lots of data is needed because it is required to have defined correspondences of text and objects. With traditional approaches, a significant effort is required to label and curate such data sets to have paired information that this image means this, or this object has this particular textual representation, etc. However, this is not the case when using the disclosed techniques.

Another benefit of the presented techniques is that the task heads can be switched. For example, a user has 500 images, and the system can be configured to perform classification on the images, perform object detection, or segment the images into categories.

In summary, the disclosed methods may provide the following example features:

(i) Novel methods to learn embeddings from many modalities. The method has a common backbone to process the different modalities and perform different tasks. In some examples, the proposed method worked well with RGB images and videos, depth images, point clouds, audio, speech, and text data.

(ii) Novel training mechanisms to allow learning using multiple tasks from both spatial (e.g., image, 3D point clouds, depth maps) and temporal (e.g, video, audio, speech, text) data. Owing to the common backbone of the method and a synchronous training mechanism, the method shares knowledge between different modalities and tasks, resulting in improved performance and generalization.

(iii) Infusing cross-domain information in the feature vectors, e.g. allowing embeddings from text data to be close to similar data in the image domain.

(iv) An iterative training mechanism that mixes modalities and group tasks. Different from existing approaches, self-supervised masked pretraining is performed across visual as well as non-visual modalities.

(v) With exhaustive experiments on numerous popular benchmarks across, it was proven that the proposed framework achieved state-of-the-art results or performed close to other methods.

(vi) The generalization ability of the proposed framework was proven by demonstrating the robust performance of the learned embeddings on unseen tasks.

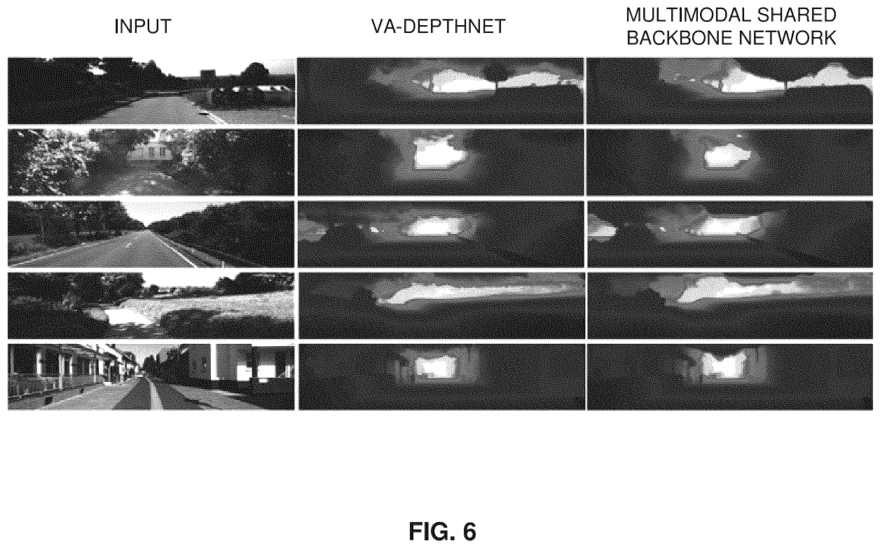

FIG. 6 illustrates some example results for different approaches according to some examples. Testing was performed using results on the test set of KITTI Depth Prediction. FIG. 6 shows the RGB input image on the left, the outputs from VA-DepthNet in the middle, and the outputs using the multimodal shared backbone network on the right.

Some examples showed superior depth perception at boundaries and distant objects. Notably, the presented techniques offer enhanced depth discernment for objects such as the bus shelter (top and middle images) and houses (bottom image).

Testing was performed on multiple modalities, data sets, and existing methods. Some example implementations outperformed the existing methods by 5% to 15% across various modalities on a variety of tasks specific to those modalities. Further, the presented techniques provided state-of-the-art results on generalization (that is, provide state-of-the-art results even for data that the network has not received). This means that the information used during training was helpful for different tasks.

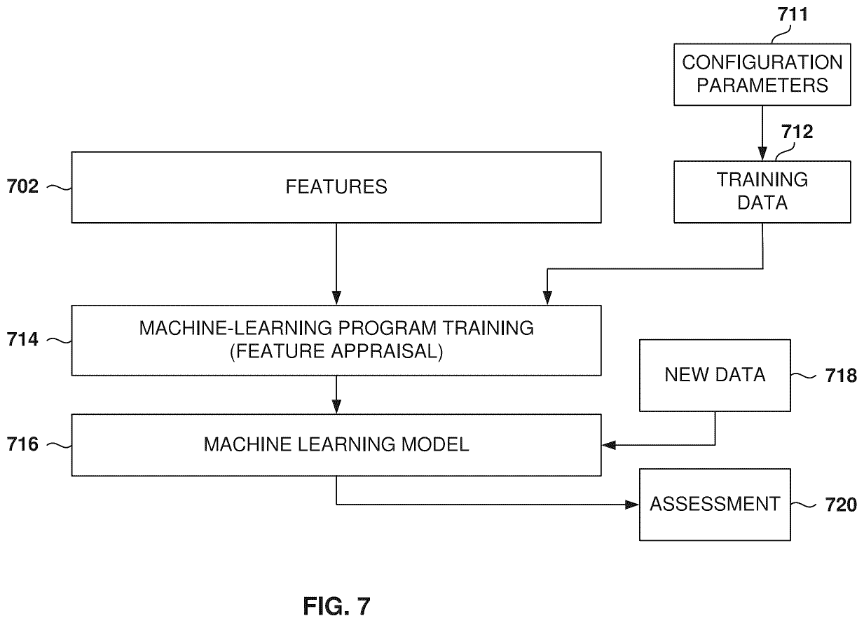

FIG. 7 illustrates the training and use of a machine-learning model 716, according to some example examples. In some examples, machine learning (ML) models 716 are utilized to perform multimodal tasks, such as object classification, object detection, text summarization, image recognition, scene recognition, action recognition, etc.

Machine Learning (ML) is an application that provides computer systems the ability to perform tasks without explicitly being programmed by making inferences based on patterns found in the analysis of data. Machine learning explores the study and construction of algorithms, also referred to herein as tools, which may learn from existing data and make predictions about new data. Such machine-learning algorithms operate by building an ML model 716 from training data 712 in order to make data-driven predictions or decisions expressed as outputs or assessments 720. Although examples are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is essential so that the training is able to identify the correlations within the data.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm, using information that is neither classified nor labeled and allowing the algorithm to act on that information without guidance. Unsupervised ML is useful in exploratory analysis because it can automatically identify structure in data.

Typical tasks for supervised ML are classification problems and regression problems. Classification problems, also referred to as categorization problems, aim to classification items into one of several category values (for example, is this object an apple or an orange?). Regression algorithms aim to quantify some items (for example, by providing a score to the value of some input). Some examples of commonly used supervised ML algorithms are Logistic Regression (LR), Naive-Bayes, Random Forest (RF), neural networks (NN), deep neural networks (DNN), matrix factorization, and Support Vector Machines (SVM).

Some typical tasks for unsupervised ML include clustering, representation learning, and density estimation. Some examples of commonly used unsupervised ML algorithms are K-means clustering, principal component analysis, and autoencoders.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit training samples and generalize poorly to new samples. Feature extraction includes constructing combinations of variables to get around these large-data-set problems while still describing the data with sufficient accuracy for the desired purpose.

In some examples, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same or a similar amount of information.

The training data 712 comprises examples of values for the features 702. In some examples, the training data comprises labeled data with examples of values for the features 702 and labels indicating the outcome, such as information on the content of an image, bounding boxes, text corresponding to audio, text transcript for a video recording, etc. The machine-learning algorithms utilize the training data 712 to find correlations among identified features 702 that affect the outcome. A feature 702 is an individual measurable property of a phenomenon being observed. The concept of a feature is related to that of an explanatory variable used in statistical techniques such as linear regression. Choosing informative, discriminating, and independent features is essential for the effective operation of ML in pattern recognition, classification, and regression. Features may be of different types, such as numeric, strings, categorical, and graph. A categorical feature is a feature that may be assigned a value from a plurality of predetermined possible values (e.g., this animal is a dog, a cat, or a bird).

During training 714, the ML program also referred to as ML algorithm or ML tool, analyzes the training data 712 based on identified features 702 and configuration parameters 711 defined for the training. The result of the training 714 is the ML model 716, which is capable of taking inputs to produce assessments.

Training an ML, algorithm involves analyzing large amounts of data (e.g., from several gigabytes to a terabyte or more) in order to find data correlations. The ML algorithms utilize the training data. 712 to find correlations among the identified features 702 that affect the outcome or assessment 720. In some examples, the training data 712 includes labeled data, which is known data for one or more identified features 702 and one or more outcomes, such as object classification, object detection, text summarization, image recognition, scene recognition, action recognition, etc.

The ML algorithms usually explore many possible functions and parameters before finding what the ML algorithms identify to be the best correlations within the data; therefore, training may make use of large amounts of computing resources and time.

Many ML algorithms include configuration parameters 711, and the more complex the ML algorithm, the more parameters there are that are available to the user. The configuration parameters 711 define variables for an ML algorithm in the search for the best ML model. The training parameters include model parameters and hyperparameters. Model parameters are learned from the training data, whereas hyperpararmeters are not learned from the training data but are instead provided to the ML algorithm.

Some examples of model parameters include maximum model size, maximum number of passes over the training data data shuffle type, regression coefficients, decision tree split locations, and the like. Hyperparameters may include the number of hidden layers in a neural network, the number of hidden nodes in each layer, the learning rate (perhaps with various adaptation schemes for the learning rate), the regularization parameters, types of nonlinear activation functions, and the like. Finding the correct (or the best) set of hyperparameters can be a very time-consuming task that makes use of a large amount of computer resources.

When the ML model 716 is used to perform an assessment, new data 718 is provided as input to the ML model 716, and the ML model 716 generates the assessment 720 as output.

In some examples, results obtained by the model 716 during operation (e.g., assessment 720 produced by the model in response to inputs) are used to improve the training data 712, which is then used to generate a newer version of the model. Thus, a feedback loop is formed to use the results obtained by the model to improve the model.

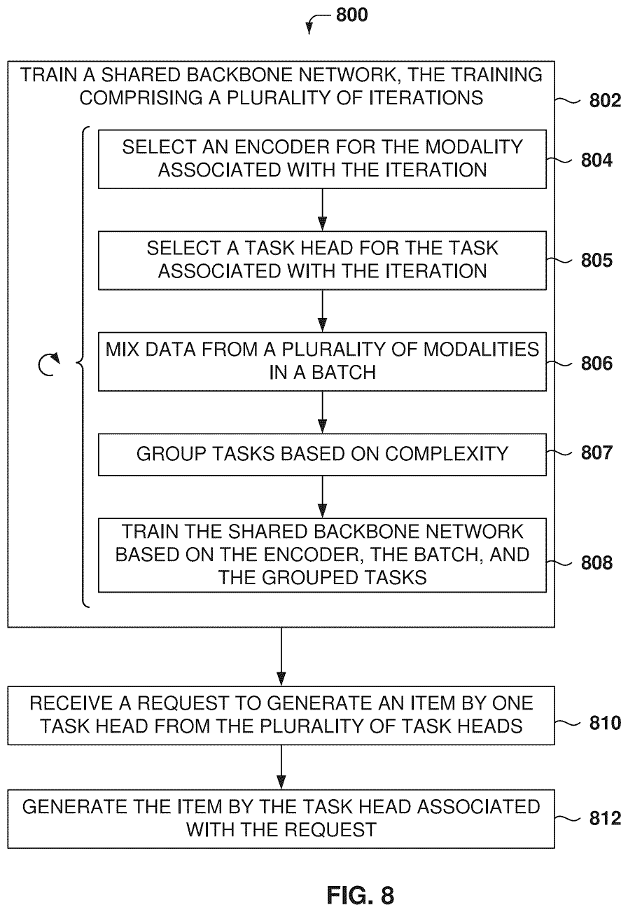

FIG. 8 is a flowchart of a method 800 for learning robust data representations, according to some examples. While the various operations in this flowchart are presented and described sequentially, one of ordinary skill will appreciate that some or all of the operations may be executed in a different order, be combined or omitted, or be executed in parallel.

Operation 802 is for training a shared backbone network to embed items from a plurality of modalities in a common embedding space and to perform a plurality of tasks. The training comprises a plurality of iterations, where each iteration comprises operations 804-808.

Operation 804 is for selecting a task head for the task associated with the iteration.

From operation 804, method 800 flows to operation 805 for selecting an encoder for the modality associated with the iteration.

From operation 805, method 800 flows to operation 806 for mixing data from a plurality of modalities in a batch.

From operation 806, method 800 flows to operation 807 for grouping tasks based on complexity.

From operation 807, method 800 flows to operation 808 for training the shared backbone network based on the encoder, the batch, and the grouped tasks. The training of the shared backbone network comprises training a plurality of task heads for the respective plurality of tasks.

From operation 802, method 800 flows to operation 810 for receiving a request to generate an item by one task head from the plurality of task heads.

From operation 810, method 800 flows to operation 812 for generating the item by the task head associated with the request.

In one example, the shared backbone network comprises: encoders for the plurality of modalities, a projection layer, a transformer, a vectorizer, and the plurality of task heads.

In one example, the projection layer takes as input a feature embedding of a modality item and meta tokens derived from the modality item and outputs patches.

In one example, each meta token is a vector representation that encodes a type of modality, size of temporal dimension, height, width in spatial dimension, number of channels, and length or number of tokens.

In one example, the transformer takes as input patches generated by the projection layer and outputs feature vectors.

In one example, the vectorizer takes as inputs feature vectors created by the transformer and outputs an embedding of a modality item.

In one example, generating the item further comprises: generating, by the shared backbone network, an embedding of an input included in the request; and providing the embedding of the input to the task head for generating the item.

In one example, the encoder takes as input a modality item and creates a feature embedding of the modality item.

In one example, the plurality of modalities comprises image, depth map, 3D point cloud, video, audio, and text.

In one example, the plurality of tasks comprises any combination of object classification, object detection, text summarization, image recognition, scene recognition, and action recognition.

Another general aspect is for a system that includes a memory comprising instructions and one or more computer processors. The instructions, when executed by the one or more computer processors, cause the one or more computer processors to perform operations comprising: training a shared backbone network to embed items from a plurality of modalities in a common embedding space and to perform a plurality of tasks, the training comprising a plurality of iterations and each iteration comprising: selecting an encoder for the modality associated with the iteration; selecting a task head for the task associated with the iteration; mixing data from a plurality of modalities in a batch; grouping tasks based on complexity; and training the shared backbone network based on the encoder, the batch, and the grouped tasks, the training the shared backbone network comprising training a plurality of task heads for the respective plurality of tasks; receiving a request to generate an item by one task head from the plurality of task heads; and generating the item by the task head associated with the request.

In yet another general aspect, a tangible machine-readable storage medium (e.g., a non-transitory storage medium) includes instructions that, when executed by a machine, cause the machine to perform operations comprising: training a shared backbone network to embed items from a plurality of modalities in a common embedding space and to perform a plurality of tasks, the training comprising a plurality of iterations and each iteration comprising: selecting an encoder for the modality associated with the iteration; selecting a task head for the task associated with the iteration; mixing data from a plurality of modalities in a batch; grouping tasks based on complexity; and training the shared backbone network based on the encoder, the batch, and the grouped tasks, the training the shared backbone network comprising training a plurality of task heads for the respective plurality of tasks; receiving a request to generate an item by one task head from the plurality of task heads; and generating the item by the task head associated with the request.

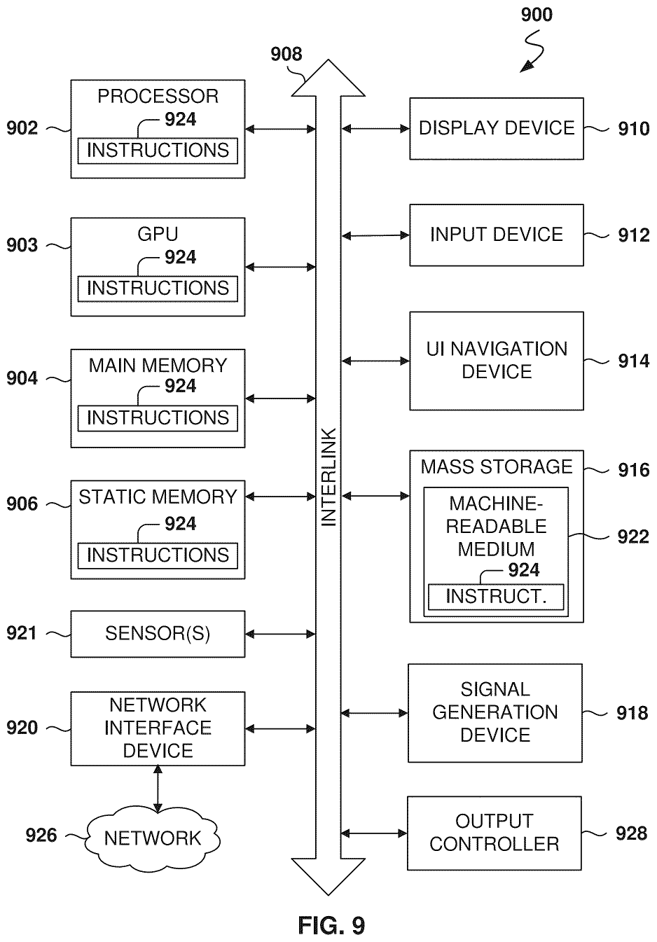

FIG. 9 is a block diagram illustrating an example of a machine 900 upon or by which one or more example process examples described herein may be implemented or controlled. In alternative examples, the machine 900 may operate as a standalone device or be connected (e.g., networked) to other machines. In a networked deployment, the machine 900 may operate in the capacity of a server machine, a client machine, or both in server-client network environments. In an example, the machine 900 may act as a peer machine in a peer-to-peer (P2P) (or other distributed) network environment. Further, while only a single machine 900 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, various components, or mechanisms. Circuitry is a collection of circuits implemented in tangible entities, including hardware (e.g., simple circuits, gates, logic). Circuitry membership may be flexible over time and underlying hardware variability. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits), including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other circuitry components when the device operates. In an example, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The machine 900 (e.g., computer system) may include a hardware processor 902 (e.g., a central processing unit (CPU), a hardware processor core, or any combination thereof), a graphics processing unit (GPU 903), a main memory 904, and a static memory 906, some or all of which may communicate with each other via an interlink 908 (e.g., bus). The machine 900 may further include a display device 910, an alphanumeric input device 912 (e.g., a keyboard), and a user interface (Ut) navigation device 914 (e.g., a mouse). In an example, the display device 910, alphanumeric input device 912, and UT navigation device 914 may be a touch screen display. The machine 900 may additionally include a mass storage device 916 (e.g., drive unit), a signal generation device 918 (e.g., a speaker), a network interface device 920, and one or more sensors 921, such as a Global Positioning System (GPS) sensor, compass, accelerometer, or another sensor. The machine 900 may include an output controller 928, such as a serial (e.g., universal serial bus (USB)), parallel, or other wired or wireless (e.g., infrared (IR), near field communication (NFC)) connection to communicate with or control one or more peripheral devices (e.g. a printer, card reader).

Processor 902 refers to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor 902 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

The processor 902 may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. Processor 902 may be emulated in software, running on a physical processor, as a virtual processor or virtual circuit. The virtual processor may behave like an independent processor but is implemented in software rather than hardware.

The mass storage device 916 may include a machine-readable medium 922 on which one or more sets of data structures or instructions 924 (e.g., software) embodying or utilized by any of the techniques or functions described herein. The instructions 924 may also reside, completely or at least partially, within the main memory 904, within the static memory 906, within the hardware processor 902, or the GPU 903 during execution thereof by the machine 900. For example, one or any combination of the hardware processor 902, the G PUT 903, the main memory 904, the static memory 906, or the mass storage device 916 may constitute machine-readable media.

While the machine-readable medium 922 is illustrated as a single medium, the term “machine-readable medium” may include a single medium or multiple media (e.g., a centralized or distributed database and associated caches and servers) configured to store one or more instructions 924.

The term “machine-readable medium” may include any medium that is capable of storing, encoding, or carrying instructions 924 for execution by the machine 900 and that causes the machine 900 to perform any one or more of the techniques of the present disclosure or that is capable of storing, encoding, or carrying data structures used by or associated with such instructions 924. Non-limiting machine-readable medium examples may include solid-state memories and optical and magnetic media. For example, a massed machine-readable medium comprises a machine-readable medium 922 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may be transmitted or received over a communications network 926 using a transmission medium via the network interface device 920.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented separately. These and other variations, modifications, additions, and improvements fall within the scope of the subject matter herein.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Additionally, as used in this disclosure, phrases of the form “at least one of an A, a B, or a C,” “at least one of A, B, and C,” and the like should be interpreted to select at least one from the group that comprises “A, B, and C,” Unless explicitly stated otherwise in connection with a particular instance, in this disclosure, this manner of phrasing does not mean “at least one of A, at least one of B, and at least one of C.” As used in this disclosure, the example “at least one of an A, a B, or a C” would cover any of the following selections: {A}, {B}{C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various examples of the present disclosure. In general, structures and functionality are presented as separate resources in the example; configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. Accordingly, the specification and drawings are to be regarded in an illustrative rather than a restrictive sense.

What is claimed is:

1. A computer-implemented method comprising:
training a shared backbone network to embed items from a plurality of modalities in a common embedding space and to perform a plurality of tasks, the training comprising a plurality of iterations and each iteration comprising:
selecting an encoder for the modality associated with the iteration;
selecting a task head for the task associated with the iteration;
mixing data from the plurality of modalities in a batch;
grouping tasks based on complexity; and
training the shared backbone network based on the encoder, the batch, and the grouped tasks, the training the shared backbone network comprising training a plurality of task heads for the respective plurality of tasks:
receiving a request to generate an item by one task head from the plurality of task heads; and
generating the item by the task head associated with the request.

2. The method as recited in claim 1, wherein the shared backbone network comprises:
encoders for the plurality of modalities;
a projection layer;
a transformer;
a vectorizer; and
the plurality of task heads.

3. The method as recited in claim 2, wherein the projection layer takes as input a feature embedding of a modality item and meta tokens derived from the modality item and outputs patches.

4. The method as recited in claim 3, wherein each meta token is a vector representation that encodes a type of modality, size of temporal dimension, height, width in spatial dimension, number of channels, and length or number of tokens.

5. The method as recited in claim 2, wherein the transformer takes as input patches generated by the projection layer and outputs feature vectors.

6. The method as recited in claim 2, wherein the vectorizer takes as inputs feature vectors created by the transformer and outputs an embedding of a modality item.

7. The method as recited in claim 1, wherein generating the item further comprises:
generating, by the shared backbone network, an embedding of an input included in the request; and
providing the embedding of the input to the task head for generating the item.

8. The method as recited in claim 1, wherein the encoder takes as input a modality item and creates a feature embedding of the modality item.

9. The method as recited in claim 1, wherein the plurality of modalities comprises image, depth map, 3D point cloud, video, audio, and text.

10. The method as recited in claim 1, wherein the plurality of tasks comprises any combination of object classification, object detection, text summarization, image recognition, scene recognition, and action recognition.

11. A system comprising:
a memory comprising instructions; and
one or more computer processors, wherein the instructions, when executed by the one or more computer processors, cause the system to perform operations comprising:
training a shared backbone network to embed items from a plurality of modalities in a common embedding space and to perform a plurality of tasks, the training comprising a plurality of iterations and each iteration comprising:
selecting an encoder for the modality associated with the iteration;
selecting a task head for the task associated with the iteration;
mixing data from the plurality of modalities in a batch;
grouping tasks based on complexity; and
training the shared backbone network based on the encoder, the batch, and the grouped tasks, the training the shared backbone network comprising training a plurality of task heads for the respective plurality of tasks;
receiving a request to generate an item by one task head from the plurality of task heads; and
generating the item by the task head associated with the request.

12. The system as recited in claim 11, wherein the shared backbone network comprises:
encoders for the plurality of modalities;
a projection layer;
a transformer;
a vectorizer; and
the plurality of task heads.

13. The system as recited in claim 12, wherein the projection layer takes as input a feature embedding of a modality item and meta tokens derived from the modality item and outputs patches, wherein each meta token is a vector representation that encodes a type of modality, size of temporal dimension, height, width in spatial dimension, number of channels, and length or number of tokens.

14. The system as recited in claim 12, wherein the transformer takes as input patches generated by the projection layer and outputs feature vectors, wherein the vectorizer takes as inputs the feature vectors created by the transformer and outputs an embedding of a modality item.

15. The system as recited in claim 11, wherein generating the item further comprises:
generating, by the shared backbone network, an embedding of an input included in the request; and
providing the embedding of the input to the task head for generating the item.

16. A tangible machine-readable storage medium including instructions that, when executed by a machine, cause the machine to perform operations comprising:
training a shared backbone network to embed items from a plurality of modalities in a common embedding space and to perform a plurality of tasks, the training comprising a plurality of iterations and each iteration comprising:
selecting an encoder for the modality associated with the iteration;
selecting a task head for the task associated with the iteration;
mixing data from the plurality of modalities in a batch;
grouping tasks based on complexity; and
training the shared backbone network based on the encoder, the batch, and the grouped tasks, the training the shared backbone network comprising training a plurality of task heads for the respective plurality of tasks;
receiving a request to generate an item by one task head from the plurality of task heads; and
generating the item by the task head associated with the request.

17. The tangible machine-readable storage medium as recited in claim 16, wherein the shared backbone network comprises:
encoders for the plurality of modalities;
a projection layer;
a transformer;
a vectorizer; and
the plurality of task heads.

18. The tangible machine-readable storage medium as recited in claim 17, wherein the projection layer takes as input a feature embedding of a modality item and meta tokens derived from the modality item and outputs patches, wherein each meta token is a vector representation that encodes a type of modality, size of temporal dimension, height, width in spatial dimension, number of channels, and length or number of tokens.

19. The tangible machine-readable storage medium as recited in claim 17, wherein the transformer takes as input patches generated by the projection layer and outputs feature vectors, wherein the vectorizer takes as inputs the feature vectors created by the transformer and outputs an embedding of a modality item.

20. The tangible machine-readable storage medium as recited in claim 16, wherein generating the item further comprises:
generating, by the shared backbone network, an embedding of an input included in the request; and
providing the embedding of the input to the task head for generating the item.
